(19) United States
(12) Patent Application Publication
(10) Pub. No.: US 2024/0351588 A1
(43) Pub. Date: Oct. 24, 2024

(54) ESTIMATION OF DRIVER STATE BASED ON EYE GAZE

(71) Applicant: GM GLOBAL TECHNOLOGY OPERATIONS LLC, Detroit, MI (US)

(72) Inventors: Ron M. Hecht, Raanana (IL); Shaul Oron, Rehovot (IL); Omer Tsimhoni, Bloomfield Hills, MI (US); Gershon Celniker, Netanya (IL); Daniel S. Glaser, West Bloomfield, MI (US); Yi Guo Glaser, West Bloomfield, MI (US); Andrea Forgacs, Kfar Sava (IL)

(73) Assignee: GM GLOBAL TECHNOLOGY OPERATIONS LLC, Detroit, MI (US)

(21) Appl. No.: 18/302,231

(22) Filed: Apr. 18, 2023

(51) Int. Cl. B60W 40/08; G06V 20/58; G06V 20/59

(52) U.S. Cl. CPC B60W 40/08; G06V 20/58; G06V 20/597; B60W 2420/403; B60W 2540/225; B60W 2540/229

(57) ABSTRACT

A system and method for estimation of a driver state based on eye gaze includes, capturing and sending, using an outward looking camera situated in a vehicle, a first video stream of surrounding environment to a neural controller. The neural controller, based on the first video stream, generates an expected gaze distribution. Using an inward looking camera situated in the vehicle, the camera captures and sends a second video stream of a face of a driver to an eye tracker controller, where based on the second video stream, the eye tracker controller extracts a plurality of gaze directions. A gaze distribution module generates, based on the plurality of gaze directions, an actual gaze distribution. A distance distribution controller, based on a difference between the expected gaze distribution and the actual gaze distribution, generates a distance measure where a determination is made that the distance measure exceeds a threshold.

### INTRODUCTION

Vehicles are a staple of everyday life. Special use cameras, microcontrollers, laser technologies, and sensors may be used in many different applications in a vehicle. Cameras, microcontrollers and sensors may be utilized in enhancing automated structures that offer state-of-the-art experience and services to the customers, for example in tasks such as body control, camera vision, information display, security, autonomous controls, etc. Vehicular vision systems may also be used to assist in vehicle control.

Vehicular vision systems may be used to provide the vehicle operator with information of the environment surrounding the vehicle. The vision systems may also be used to greatly reduce blind spot areas to the sides and rear of the vehicle. Vison systems may also be used to monitor the actions and movements of occupants, especially the vehicle operator. In particular, driver monitoring systems may include vision systems that may be used to track a vehicle operator's head and eye position and movement, e.g., eye gaze. Eye gaze may generally refer to the direction that a driver's eyes are fixated at any given instant. Such systems may detect an operator eye gaze and may be used in numerous useful applications including detecting driver distraction, drowsiness, situational awareness, and readiness to assume vehicle control from an automated driving mode for example. However, driver monitoring systems may require processing large amounts of image data and thus require large amounts of processing resources thereby theoretically reducing associated response times. Accordingly, it is desirable to provide an estimation of a driver state based on eye gaze patterns without the need for explicit detection of scene parameters.

### SUMMARY

Disclosed herein are a system and methods for an estimation of a driver state based on eye gaze patterns. As disclosed herein, a system estimation of a driver state based on eye gaze may include an outward looking camera, situated in a vehicle, to capture and send a first video stream of a surrounding environment to a neural controller. The neural controller, also situated in the vehicle, may generate an expected gaze distribution based on the first video stream. An inward looking camera, situated in the vehicle, may capture and send a second video stream of a face of a driver to an eye tracker controller. The eye tracker controller, based on the second video stream, may extract a plurality of gaze directions where a gaze distribution module may generate an actual gaze distribution based on the plurality of gaze directions. A distance distribution controller, situated in the vehicle, may generate a distance measure based on a difference between the expected gaze distribution and the actual gaze distribution, where if the distance measure exceeds a threshold an action may be generated.

Another aspect of the disclosure may be a system that includes an efficiency estimation component that may receive the encoded data and determine an efficiency of the encoding.

Another aspect of the disclosure may include where if the efficiency of the encoding is below a predetermined threshold the selected codebook may be replaced with a different codebook.

Another aspect of the disclosure is a system where the surrounding environment may include a forward view.

Another aspect of the disclosure is a system where the outward looking camera may be forward looking.

Another aspect of the disclosure is a system where the neural controller may detect a road junction, a target vehicle, and a pedestrian from the first video stream.

Another aspect of the disclosure is a system where the neural controller may detect a road junction, a target vehicle, and a pedestrian from the first video stream where the detection is forward facing.

Another aspect of the disclosure is a system where if the distance measure exceeds the threshold the driver may be deemed to be inattentive.

Another aspect of the disclosure is a system where if the distance measure is less than the threshold the driver may be deemed to be attentive.

Another aspect of the disclosure is a system where if the distance measure exceeds the threshold a warning indication may be generated.

Another aspect of the disclosure is a system where the distance distribution controller may generate the distance measure using a Kullback-Leibler divergence or a Jensen-Shannon divergence.

Another aspect of the disclosure may include a method for estimation of a driver state based on eye gaze that may include capturing and sending, using an outward looking camera situated in a vehicle, a first video stream of a surrounding environment to a neural controller. The method may also include generating, by the neural controller, based on the first video stream, an expected gaze distribution. In addition, the method may include capturing and sending, using an inward looking camera situated in the vehicle, a second video stream of a face of a driver to an eye tracker controller. The eye tracker controller may extract, based on the second video stream, a plurality of gaze directions of the driver. Then, a gaze distribution module may generate, based on the plurality of gaze directions, an actual gaze distribution. The method may include generating, by a distance distribution controller, a distance measure, based on a difference between the expected gaze distribution and the actual gaze distribution. The method further may include determining, by the distance distribution controller, if the distance measure exceeds a threshold.

Another aspect of the method may include where the surrounding environment includes a forward view.

Another aspect of the method may include where the outward looking camera is forward looking.

Another aspect of the method may include where generating the expected gaze distribution includes detecting, if present, a road junction, a target vehicle, and a pedestrian, from the first video stream.

Another aspect of the method may include where the detecting is forward facing.

Another aspect of the method may include determining the driver is inattentive if the distance measure exceeds the threshold.

Another aspect of the method may include determining the driver is attentive if the distance measure is less than the threshold.

Another aspect of the method may include generating a warning indication if the distance measure exceeds the threshold.

Another aspect of the method may include generating a vehicle action if the distance measure exceeds the threshold.

Another aspect of the method may include where generating the distance measure is based on a Kullback-Leibler divergence or a Jensen-Shannon divergence.

Another aspect of the disclosure may include a method for estimation of a driver state based on eye gaze including capturing and sending, using an outward, forward looking, camera situated in a vehicle, a forward view video stream of a surrounding environment to a neural controller. The method may include generating, by the neural controller, based on the forward view video stream, an expected gaze distribution, wherein generating the expected gaze distribution comprises forward facing detecting, if present, a road junction, a target vehicle, and a pedestrian. The method may include capturing and sending, using an inward looking camera situated in the vehicle, a second video stream of a face of a driver to an eye tracker controller The method may include extracting, by the eye tracker controller, based on the second video stream, a plurality of gaze directions of the driver. The method may include generating, by a gaze distribution module, based on the plurality of gaze directions, an actual gaze distribution. The method may include generating, by a distance distribution controller using a Kullback-Leibler divergence or a Jensen-Shannon divergence, a distance measure, based on a difference between the expected gaze distribution and the actual gaze distribution. The method may include determining, by the distance distribution controller, if the driver is attentive or inattentive, wherein the driver is inattentive if the distance measure exceeds a threshold, and wherein the driver is attentive if the distance measure is less than the threshold. The method may include generating a warning indication if the distance measure exceeds the threshold. The method may include generating a vehicle action if the distance measure exceeds the threshold.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIGS. 1A, 1B, and 1C are illustrations of eye gaze pattern examples, in accordance with the disclosure.

FIGS. 2A and 2B are illustrations of gaze patterns with an obstruction, in accordance with the disclosure.

FIGS. 3A and 3B are illustrations relating to a neural network prediction of eye gaze, in accordance with the disclosure.

FIGS. 4A and 4B are illustrations relating to a neural network prediction of eye gaze with an obstruction, in accordance with the disclosure.

FIGS. 5A and 5B are illustrations of a distance/divergence measure between distributions, in accordance with the disclosure.

FIG. 6 is an illustration of a distance/divergence measure between distributions, in accordance with the disclosure.

FIG. 7 is an illustration of an eye gaze neural estimation system, in accordance with the disclosure.

FIG. 8 depicts a flowchart of a method for estimation of a driver's state based on eye gaze, in accordance with the disclosure.

The appended drawings are not necessarily to scale and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The present disclosure is susceptible of embodiments in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

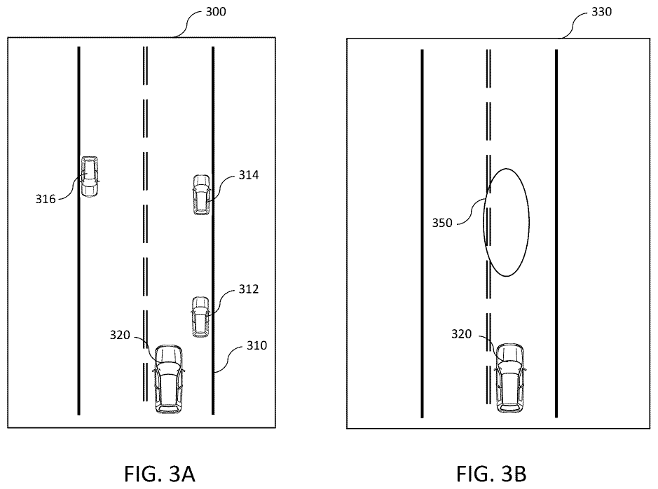

Referring to the drawings, the left most digit of a reference number identifies the drawing in which the reference number first appears (e.g., a reference number ‘310’ indicates that the element so numbered is first labeled or first appears in FIG. 3). Additionally, elements which have the same reference number, followed by a different letter of the alphabet or other distinctive marking (e.g., an apostrophe), indicate elements which may be the same in structure, operation, or form but may be identified as being in different locations in space or recurring at different points in time (e.g., reference numbers “110a” and “110b” may indicate two different input devices which may be functionally the same, but may be located at different points in a simulation arena).

Vehicles have become computationally advanced and equipped with multiple microcontrollers, sensors, processors, and control systems, including for example, autonomous vehicle and advanced driver assistance systems (AV/ADAS) such as adaptive cruise control, automated parking, automatic brake hold, automatic braking, evasive steering assist, lane keeping assist, adaptive headlights, backup assist, blind spot detection, cross traffic alert, local hazard alert, and rear automatic braking may depend on information obtained from cameras and sensors on a vehicle.

Further, during roadway operation of a vehicle by a vehicle operator, semi-autonomously or fully autonomous, the vehicle may be an observer in a driving scene which includes a driving environment, for example the roadway, surrounding infrastructure, objects, signs, hazards, and other vehicles sharing the roadway collectively referred to herein as objects or targets. Objects may be static, such as road signage, or dynamic, such as another vehicle traversing the roadway. Driver, operator, vehicle operator are terms that are meant to be interchangeable and are not meant to limit the scope of the disclosure.

Driving in a semi-autonomous mode or while using a driver assistance feature typically requires the driver to maintain an attentive state, being able to take control of the vehicle in some form or another. One approach to determining a driver's state is by monitoring an eye gaze, e.g., where the driver is looking, to determine if the driver is attentive or not. Further, estimation of a driver's state based on eye gaze can be scene invariant or scene dependent. A major advantage of scene invariant gaze analysis is in its simplicity. In some scenarios, for example, where the majority of driving is done on a highway, a single model may be sufficient as the majority of a driver eye gaze should be straight forward in the middle of the road. However, in a driving scenario that includes junctions and other obstructions the set of possible gazes is much more diverse and may require scene dependent analysis requiring detection of multiple elements. Unfortunately, explicit detection requires processing power to analyze images and the results of that analysis in not necessarily accurate.

Accordingly, this disclosure is directed to the use of a neural network that does not require explicit detection and identification of objects. A neural network may be used to estimate the expected driver gaze distribution based on an image from an outward facing camera and measure the difference, or distance, between the predicted neural gaze distribution and the actual observed driver gaze. In such an approach the detections are implicit, and the neural network processes the image in an end-to-end mechanism where the detections, if they occur, are held in an inner state of the network, especially given that most of the important information may be observed in a front facing image.

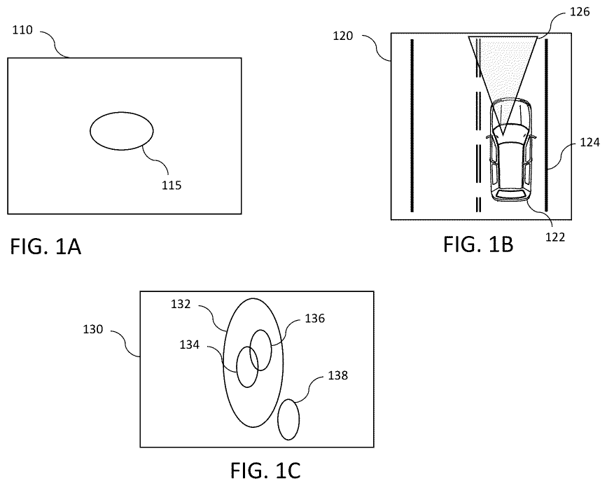

For example, FIG. 1A is an illustration of gaze pattern 110 from the perspective of a vehicle operator looking out of a front windshield, according to an embodiment of the present disclosure. Gaze pattern 110 may contain a single area, for example target area 115. Target area 115 represents a cluster of eye gaze directional points. Further, eye gaze data points are continuous, and may also be referred to as floats. Target area 115 may represent a vehicle operator's gaze straight ahead, for example when driving down a straight highway. In such a scenario there may be little need to look far right or far left. Further, such a gaze may also infer that traffic may be fairly light as there appears to be little eye gaze direction towards a rearview mirror or side mirrors, if so equipped.

FIGS. 1B and 1C are illustrations of the use of a cone bounds, according to an embodiment of the present disclosure. FIG. 1B illustrates an overhead view 120 of a vehicle 122 traveling on a road 124. Cone 126 outlines an area of gaze directions that may be considered attentive. For example, FIG. 1C is an illustration of cone and gaze pattern 130 from the perspective of a vehicle operator looking out of a front windshield, according to an embodiment of the present disclosure. Cone and gaze pattern 130 illustrates three gaze patterns, gaze pattern 134, gaze pattern 136, and gaze pattern 138. Also illustrated is cone bounds 132. As gaze pattern 134 and gaze pattern 136 are within the cone bounds 132, those gazes may be considered to be attentive. However, gaze pattern 138 is outside of the cone bounds 132 and therefore may be considered to be inattentive.

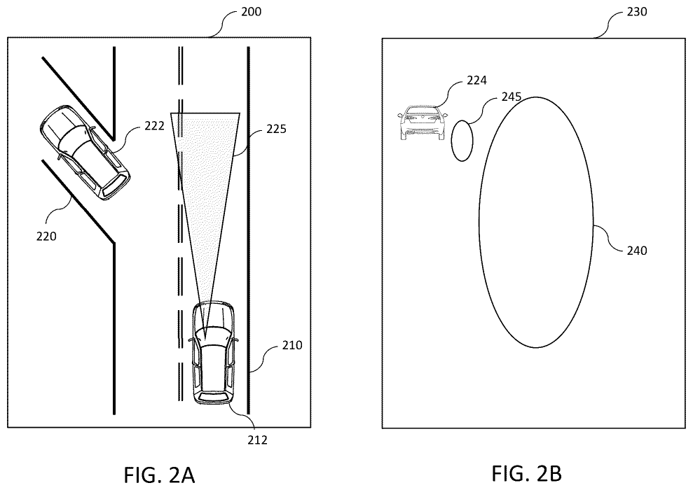

FIG. 2A is a top-view illustration of a junction within a gaze area 200, according to an embodiment of the present disclosure. Gaze area 200 shows a vehicle 212 on a road 210 where the road includes a junction 220 to the left in which a vehicle 222 is turning. FIG. 2A also illustrates a cone bounds 225 looking straight ahead, similar to that discussed in FIG. 1B. FIG. 2B illustrates an associated cone and gaze pattern 230, according to an embodiment. In FIG. 2B, vehicle 222 is shown by a rear-view vehicle 224 turning left onto the junction illustrated in FIG. 2A. However, the cone bounds 225 of FIG. 2A is illustrated as cone bounds 240 from the perspective of a vehicle operator looking out of a front windshield. Of significance is that gaze pattern 245, in the direction of vehicle 222, is outside the cone bounds 240 and hence may be considered to having the driver being inattentive. However, in this case of a junction in the road with a vehicle turning, gaze pattern 245 may well be considered attentive. Thus, the use of cone bounds in some scenarios is not an accurate method of determining a state of the driver.

FIG. 3A and FIG. 3B are illustrations of using a neural network to predict gaze patterns, according to an embodiment of the present disclosure. For example, FIG. 3A illustrates a scenario 300 in which vehicle 320 is traveling down road 310. Scenario 300 contains no junctions. Vehicle 312, vehicle 314, and vehicle 316 are parked and not moving. Given scenario 300 a neural network may learn and predict a driver gaze direction as shown in FIG. 3B. FIG. 3B illustrates neural network scenario 330 with vehicle 320 with a predicted gaze pattern 350, which is straight ahead.

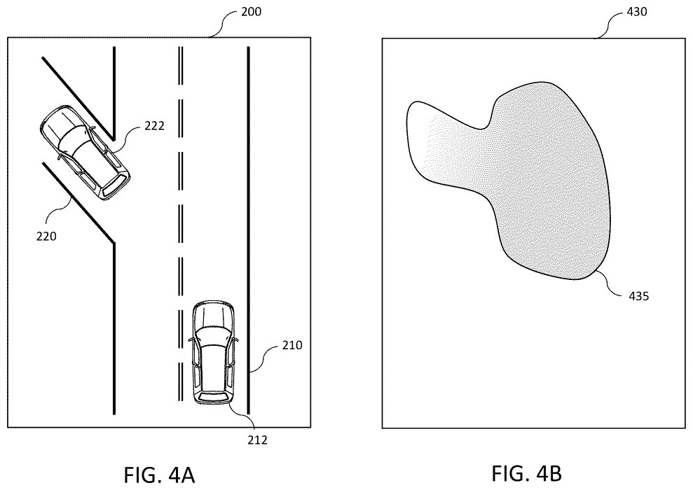

FIG. 4A and FIG. 4B are illustrations of using a neural network to predict gaze patterns where the scenario includes a junction in the road, according to an embodiment of the present disclosure. FIG. 4A is a top-view illustration of a junction within a gaze area 200, according to an embodiment of the present disclosure. Gaze area 200 shows vehicle 212 on a road 210 where the road includes a junction 220 to the left in which a vehicle 222 is turning. FIG. 4B is an illustration of a neural network scenario 430 with a predicted gaze pattern 435, which rather than just focusing on an area straight ahead, the predicted gaze pattern 435 has detected the junction and moving vehicle 222. Gaze pattern 435 is not a well defined detection. For example, a vehicle and its outline are not explicitly detected. Rather, an area covering the vehicle and possible portions of the surrounding area are identified. Thus, the gaze pattern 435 may be described as a soft detection, or a gradient detection with the densest portion centered around a detected object.

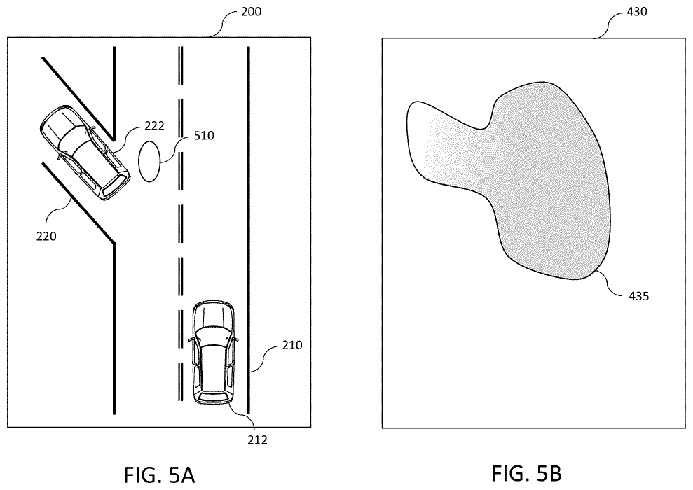

FIG. 5A again illustrates the gaze area 200 that may include vehicle 212 on a road 210 where the road includes a junction 220 to the left in which a vehicle 222 is turning, according to an embodiment of the present disclosure. Further, FIG. 5A also includes an actual driver eye gaze pattern 510, previously shown as gaze pattern 245. However, unlike FIG. 2B that used the concept of a cone bounds 240, in which gaze pattern 245 was outside, FIG. 5B illustrates the neural network predicted gaze pattern 435.

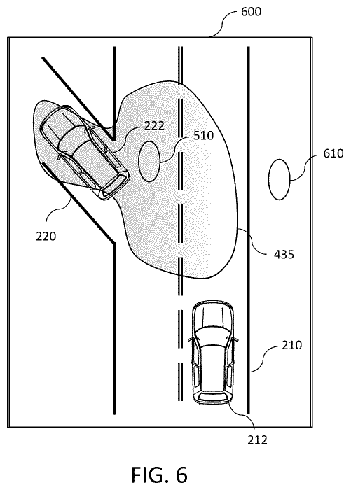

FIG. 6 is an illustration of a scenario 600, according to an embodiment of the present disclosure. Scenario 600 includes the vehicle 212 on a road 210 where the road includes a junction 220 to the left in which a vehicle 222 is turning, with an overlay of the neural network predicted gaze pattern 435 and the actual driver eye gaze pattern 510. In scenario 600 a difference between the neural network predicted gaze pattern 435 and the actual driver eye gaze pattern 510 may be calculated. In this scenario the actual driver eye gaze pattern 510 is within the neural network predicted gaze pattern 435 and therefore there is no difference, and the driver state may be considered attentive.

However, if the actual driver eye gaze pattern is shown by gaze pattern 610, gaze pattern 610 is outside the neural network predicted gaze pattern 435 and therefore there is a significant difference, or distance. The difference, or distance, can be quantified and if that difference is greater than a threshold amount then additional actions may be generated, such as a driver warning or other type of steering control or feedback.

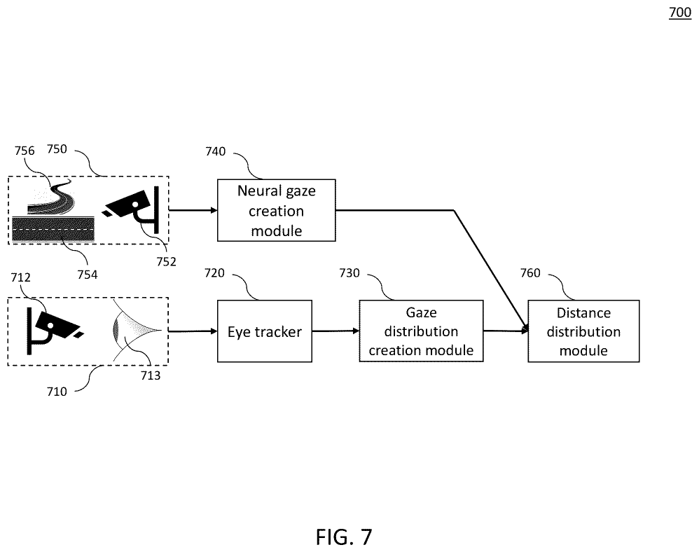

FIG. 7 is an illustration of an eye gaze neural estimation system 700, according to an embodiment of the present disclosure. System 700 may include an inward facing camera component 710 that may include a camera 712 directed to the face and eyes 713 of the vehicle operator. Camera 712 may be another type of imaging device including but not limited to an optical camera, an infrared imaging device, a light-emitting-diode (LED) device, an ultrasound sensor, and the like.

System 700 may also include an eye tracker controller 720, a gaze distribution creation module 730. In an embodiment, system 700 may include where camera 712 produces an image stream of the vehicle operator's face including the eyes 713 and forwards that image stream to the eye tracker controller 720. Eye tracker controller 720 may then analyze the image stream to estimate a stream of gaze directions of the vehicle operator. Gaze distribution creation module 730 may then generate, based on the stream of gazes of the vehicle operator, a distribution of the actual gazes of the vehicle operator, for example, the actual driver eye gaze pattern 510 and gaze pattern 610.

System 700 may also include an outward facing camera component 750 that may include an outward facing camera 752 directed towards the surrounding environment, for example a straight roadway 754 or a curved roadway 756. The surrounding environment may include other attributes, for example an intersection, other vehicles, buildings, people, or other objects. Further, inward facing camera 712 and outward facing camera 752 may include additional image capture devices facing inwards and/or outwards. For example, outward facing camera component 750 may include multiple image capture devices situated around the outside of a vehicle to provide a three-hundred-sixty-degree view. However, in an embodiment, outward facing camera 752 may be limited to a forward view of the environment.

In a similar manner, inward facing camera component 710 may include multiple image capture devices and controllers situated around the inside of a vehicle. Further, in addition to including additional image capture device inside and outside of the vehicle, in an embodiment, a single image capture device producing a video stream may include multiple controllers and processors where each controller or processor may be dedicated to a specific function regarding the video stream. For example, processor to analyze a soundtrack associated with the video stream.

System 700 may include where outward facing camera 752 sends one or more video streams to the neural gaze creation module 740. In an embodiment, the one or more video streams are primarily forward looking, providing a forward view in front of the vehicle. Accordingly, the neural gaze creation module 740 may concentrate its processing on a more limited view, in contrast to a 360 degree image analysis. In addition, as previously discussed, the generation of the predicted gaze patterns is a soft detection rather than an absolute detection and identification of objects. Thus, the neural gaze creation module 740 may be configured to identify one or more areas, in some cases the one or more areas may be a continuous shape that identifies areas of obstructions and hence areas of expected gaze distribution.

Distance distribution module 760 may be directed to compare the output of the neural gaze creation module 740, the expected gaze distribution based on the neural network, with the output of the gaze distribution creation module 730, the actual gaze distribution of the driver. Distance distribution module 760 may then estimate or measure the difference, or distance, between the actual gaze directions of the driver with the expected gaze directions of the neural network.

The estimation of the distance measures between the two distributions may indicate the attentiveness of the driver. Further, distance measures between the distributions may be determined by a variety of algorithms, for example, the Kullback-Leibler divergence or a Jensen-Shannon divergence. In addition, other methods to estimate the distance measure between distribution may also include a log likelihood or a Gaussian related score approach.

Based on the difference between the actual gaze directions of the driver with the expected gaze directions of the neural network, other actions may be taken. For example, a warning indication or alert to the driver may be generated. Or, a haptic feedback signal to the driver, or even steering control or another type of driver assistance function may be initiated.

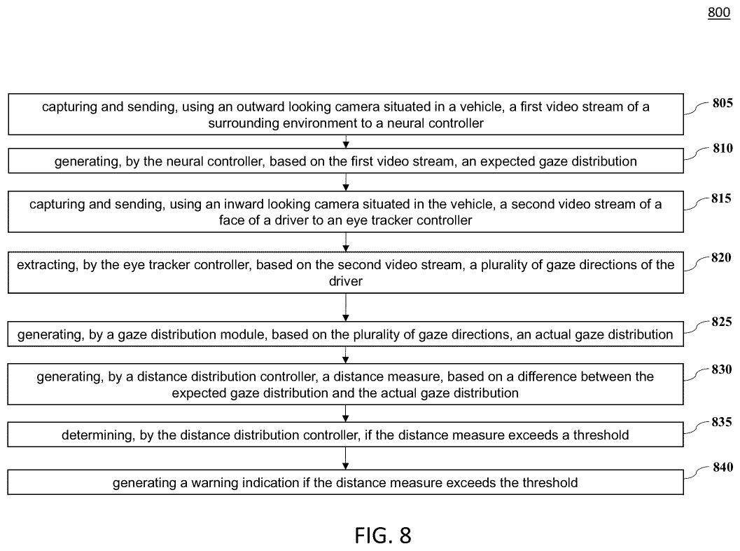

FIG. 8 illustrates a detail flowchart of a method 800 for estimation of a driver state based on eye gaze, according to an embodiment of the present disclosure. Step 805 may include capturing and sending, using an outward looking camera situated in a vehicle, a first video stream of a surrounding environment to a neural controller. As discussed in FIG. 7, system 700 may include an outward facing camera 752 directed forwards, for example a straight roadway 754 or a curved roadway 756. The surrounding environment may include other attributes, for example an intersection, other vehicles, buildings, people, or other objects.

Step 810 may include generating, by the neural controller, based on the first video stream, an expected gaze distribution, that may also be referred to as a predicted gaze pattern. As discussed in FIG. 7, the generation of the expected gaze patterns is a soft detection rather than an absolute detection and identification of objects. The neural gaze creation module 740 may be configured to identify one or more areas, in some cases the one or more areas may be a continuous shape that identifies areas of obstructions and hence areas of expected gaze distribution.

Step 815 may include capturing and sending, using an inward looking camera situated in the vehicle, a second video stream of a face of a driver to an eye tracker controller. As discussed in FIG. 7, the inward facing camera component 710 may include a camera 712 directed to the face and eyes 713 of the vehicle operator, where camera 712 may produce an image stream of the vehicle operator's face include the eyes 713 and forwards that image stream to the eye tracker controller 720.

Step 820 may include extracting, by the eye tracker controller, based on the second video stream, a plurality of gaze directions, an actual gaze distribution. As discussed in FIG. 7, eye tracker controller 720 may then analyze the image stream to estimate a stream of gaze directions of the vehicle operator.

Step 825 may include generating, by a gaze distribution module, based on the plurality of gaze directions, an actual gaze distribution. As discussed in FIG. 7, the gaze distribution creation module 730 may generate, based on the stream of gazes of the vehicle operator, a distribution of the actual gazes of the vehicle operator, for example, the actual driver eye gaze pattern 510 and gaze pattern 610.

Step 830 may include generating, by a distance distribution controller, a distance measure, based on a difference between the expected gaze distribution and the actual gaze distribution. As discussed in FIG. 7, the distance distribution module 760 may compare the output of the neural gaze creation module 740, the expected gaze distribution based on the neural network, with the output of the gaze distribution creation module 730, the actual gaze distribution of the driver. Distance distribution module 760 may then estimate or measure the difference, or distance, between the actual gaze directions of the driver with the expected gaze directions of the neural network. Further, the estimation of the distance measures between the two distributions may indicate the attentiveness of the driver where the distributions may be determined by a variety of algorithms, for example, the Kullback-Leibler divergence or a Jensen-Shannon divergence.

Step 835 may include determining, by the distance distribution controller, if the distance measure exceeds a threshold. As mentioned, the distance measures between the two distributions may indicate the attentiveness of the driver where the greater the distance the more likely the driver is not being attentive to driving. Therefore, a threshold may be set such that a determination may be made if the distance is greater than the threshold.

Step 840 may include generating a warning indication if the distance measure exceeds the threshold. As discussed in FIG. 6, if the distance is greater than a threshold amount then additional actions may be generated, such as a driver warning or other type of steering control or feedback.

Method 800 may then end.

The description and abstract sections may set forth one or more embodiments of the present disclosure as contemplated by the inventor(s), and thus, are not intended to limit the present disclosure and the appended claims.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof may be appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments.

Exemplary embodiments of the present disclosure have been presented. The disclosure is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the disclosure.

What is claimed is:

1. A system for estimation of a driver state based on eye gaze comprising:
an outward looking camera, situated in a vehicle, configured to capture and send a first video stream of a surrounding environment to a neural controller;
the neural controller, situated in the vehicle, configured to generate an expected gaze distribution based on the first video stream;
an inward looking camera, situated in the vehicle, configured to capture and send a second video stream of a face of a driver to an eye tracker controller, wherein the eye tracker controller, based on the second video stream, is configured to extract a plurality of gaze directions and generate an actual gaze distribution; and
a distance distribution controller, situated in the vehicle, configured to generate a distance measure based on a difference between the expected gaze distribution and the actual gaze distribution, wherein if the distance measure exceeds a threshold an action is generated.

2. The system of claim 1, wherein the surrounding environment comprises a forward view.

3. The system of claim 1, wherein the outward looking camera is forward looking.

4. The system of claim 1, wherein the neural controller is configured to detect a road junction, a target vehicle, and a pedestrian from the first video stream.

5. The system of claim 4, wherein the detection is forward facing.

6. The system of claim 1, wherein if the distance measure exceeds the threshold the driver is deemed to be inattentive.

7. The system of claim 1, wherein if the distance measure is less than the threshold the driver is deemed to be attentive.

8. The system of claim 1, wherein if the distance measure exceeds the threshold a warning indication is generated.

9. The system of claim 1, wherein the distance distribution controller is configured to generate the distance measure using a Kullback-Leibler divergence or a Jensen-Shannon divergence.

10. A method for estimation of a driver state based on eye gaze comprising:
capturing and sending, using an outward looking camera situated in a vehicle, a first video stream of a surrounding environment to a neural controller;
generating, by the neural controller, based on the first video stream, an expected gaze distribution;
capturing and sending, using an inward looking camera situated in the vehicle, a second video stream of a face of a driver to an eye tracker controller;
extracting, by the eye tracker controller, based on the second video stream, a plurality of gaze directions of the driver;
generating, by a gaze distribution module, based on the plurality of gaze directions, an actual gaze distribution;
generating, by a distance distribution controller, a distance measure, based on a difference between the expected gaze distribution and the actual gaze distribution; and
determining, by the distance distribution controller, if the distance measure exceeds a threshold.

11. The method of claim 10, wherein the surrounding environment comprises a forward view.

12. The method of claim 10, wherein the outward looking camera is forward looking.

13. The method of claim 10, wherein generating the expected gaze distribution comprises detecting, if present, a road junction, a target vehicle, and a pedestrian, from the first video stream.

14. The method of claim 13, wherein the detecting is forward facing.

15. The method of claim 10, further comprising determining the driver is inattentive if the distance measure exceeds the threshold.

16. The method of claim 10, further comprising determining the driver is attentive if the distance measure is less than the threshold.

17. The method of claim 10, further comprising generating a warning indication if the distance measure exceeds the threshold.

18. The method of claim 10, further comprising generating a vehicle action if the distance measure exceeds the threshold.

19. The method of claim 10, wherein generating the distance measure comprises a Kullback-Leibler divergence or a Jensen-Shannon divergence.

20. A method for estimation of a driver state based on eye gaze comprising:
capturing and sending, using an outward, forward looking, camera situated in a vehicle, a forward view video stream of a surrounding environment to a neural controller;
generating, by the neural controller, based on the forward view video stream, an expected gaze distribution, wherein generating the expected gaze distribution comprises forward facing detecting, if present, a road junction, a target vehicle, and a pedestrian;
capturing and sending, using an inward looking camera situated in the vehicle, a second video stream of a face of a driver to an eye tracker controller;
extracting, by the eye tracker controller, based on the second video stream, a plurality of gaze directions of the driver;
generating, by a gaze distribution module, based on the plurality of gaze directions, an actual gaze distribution;
generating, by a distance distribution controller using a Kullback-Leibler divergence or a Jensen-Shannon divergence, a distance measure, based on a difference between the expected gaze distribution and the actual gaze distribution;
determining, by the distance distribution controller, if the driver is attentive or inattentive, wherein the driver is inattentive if the distance measure exceeds a threshold, and wherein the driver is attentive if the distance measure is less than the threshold;
generating a warning indication if the distance measure exceeds the threshold; and
generating a vehicle action if the distance measure exceeds the threshold.
